(19) United States
(12) Patent Application Publication
(10) Pub. No.: US 2024/0254054 A1
(43) Pub. Date: Aug. 1, 2024

(54) EUTECTIC CERAMIC FIBER AND EUTECTIC CERAMIC FIBER AGGREGATE

(71) Applicant: JAPAN ULTRA-HIGH TEMPERATURE MATERIALS RESEARCH CENTER, Yamaguchi (JP)

(72) Inventors: Hironaga IGUCHI, Yamaguchi (JP); Hideki OHTSUBO, Yamaguchi (JP); Norifumi MIYAMOTO, Yamaguchi (JP); Ryoichi MIYAUCHI, Yamaguchi (JP); Yuki IZUMICHI, Yamaguchi (JP); Narihito NAKAGAWA, Yamaguchi (JP)

(21) Appl. No.: 18/425,423

(22) Filed: Jan. 29, 2024

(30) Foreign Application Priority Data
Jan. 31, 2023 (JP) 2023-013155

(51) Int. Cl. C04B 35/622

(52) U.S. Cl. CPC C04B 35/62236; C04B 2235/3244; C04B 2235/5224; C04B 2235/5264; C04B 2235/762

(57) ABSTRACT

Provided is a eutectic ceramic fiber which has high tensile strength and whose microstructure is not easily coarsened even in a case where the eutectic ceramic fiber is exposed to high temperature air for a long time. The eutectic ceramic fiber includes a Y₃Al₅O₁₂ matrix and rod-shaped Y₂O₃-containing cubic crystals of ZrO₂ present in such a manner as to be dispersed in the Y₃Al₅O₁₂ matrix. The Y₃Al₅O₁₂ matrix is a continuous phase, and the rod-shaped Y₂O₃-containing cubic crystals of ZrO₂ are oriented in a longitudinal direction of the eutectic ceramic fiber.

This Nonprovisional application claims priority under 35 U.S.C. § 119 on Patent Application No. 2023-013155 filed in Japan on Jan. 31, 2023, the entire contents of which are hereby incorporated by reference.

### TECHNICAL FIELD

The present invention relates to a eutectic ceramic fiber and a eutectic ceramic fiber aggregate. More specifically, the present invention relates to a ceramic fiber and a ceramic fiber aggregate that are used in a wide range of applications such as a reinforcing fiber of a high temperature structure ceramic composite material applied to, for example, a gas turbine member.

### BACKGROUND ART

Examples of a commercially available product of a reinforcing fiber of a high temperature structure ceramic composite material applied to, for example, a gas turbine member include SiC-based fibers such as Nicalon (registered trademark) and Tyranno fiber (registered trademark), and Al₂O₃-based fibers such as NEXTEL (registered trademark). However, an SiC-based fiber is easily degraded by oxidation at a temperature higher than 1,300° C., and an Al₂O₃-based fiber that is exposed to a temperature higher than 1,200° C. for a long time deteriorates due to coarsening of a microstructure by grain growth progress.

Ordinarily, an oxide fiber such as an Al₂O₃-based fiber is a polycrystalline body composed of fine grains or an amorphous body, and is produced by spinning and firing a precursor of, for example, an oxide sol or a metal alkoxide. Thus, at a high temperature, in the case of a polycrystalline body, crystal grain growth occurs, and, in the case of an amorphous body, crystal grain precipitation and subsequent grain growth occur, and fiber deterioration is easily advanced.

For example, Patent Literature 1 discloses the following problem. Specifically, in a method for producing a stabilized zirconia fiber by a conventional inorganic salt method or sol-gel method, a resulting fiber is a polycrystalline body. Thus, the resulting fiber easily deteriorates at a high temperature due to grain growth and is also insufficient in, for example, mechanical strength. Furthermore, Patent Literature 1 discloses, as a means for solving the above problem, a continuous zirconia fiber production method in which an alkoxide is used as a raw material, in which impurities such as alkali are very few, and which makes it possible to provide an amorphous structure obtained by controlling an amount of carbon contained. However, also in a low crystalline zirconia fiber that is considered to have the amorphous structure disclosed in Patent Literature 1, crystal grain precipitation caused by crystallization is expected to occur at a high temperature. Thus, it is not necessarily possible to thoroughly suppress crystal grain growth progressing after crystal grain precipitation.

Meanwhile, it is known that as compared with sintered ceramics of a polycrystalline body having a crystal grain aggregated structure, some eutectic ceramics produced by unidirectional solidification from a melt are not only smaller in temperature dependence of mechanical strength but also less likely to change in microstructure even when exposed to a high temperature for a long time.

For example, Non-patent Literature 1 discloses a result obtained by comparing (a) thermal stability of an Al₂O₃/Er₃Al₅O₁₂ eutectic composite material produced by a Bridgman method and (b) thermal stability of an Al₂O₃/Er₃Al₅O₁₂ sintered composite material produced by a sintering method. In more detail, Non-patent Literature 1 indicates that the Al₂O₃/Er₃Al₅O₁₂ sintered composite material heated at 1973 K (1,700° C.) shows a remarkable decrease in grain growth and bending strength after 50-hour heating, whereas neither a change in microstructure nor a decrease in bending strength is observed, even after 500-hour heating, in the Al₂O₃/Er₃Al₅O₁₂ eutectic composite material whose composition is identical to the composition of the Al₂O₃/Er₃Al₅O₁₂ sintered composite material.

Thus, an attempt has been made to form such eutectic ceramics into fibers with the aim of developing ceramic fibers having novel thermal stability.

For example, Patent Literature 2 and non-Patent Literature 2 each disclose a Al₂O₃/Y₃Al₅O₁₂ eutectic ceramic fiber. Non-patent Literature 2 indicates that an example of the Al₂O₃/Y₃Al₅O₁₂ eutectic ceramic fiber hardly changes in microstructure even when heated in air at 1,500° C. for 75 hours.

Non-Patent Literature 3 discloses not only an Al₂O₃/Y₃Al₅O₁₂ eutectic ceramic fiber but also Al₂O₃/Dy₃Al₅O₁₂, Al₂O₃/Ho₃Al₅O₁₂, Al₂O₃/Er₃Al₅O₁₂, Al₂O₃/Tm₃Al₅O₁₂, Al₂O₃/Yb₃Al₅O₁₂, Al₂O₃/Lu₃Al₅O₁₂, Al₂O₃/EuAlO₃, and Al₂O₃/GdAlO₃ eutectic ceramic fibers.

However, these conventional eutectic ceramic fibers have a disadvantage of having low tensile strength for use as reinforcing fibers of a structure ceramic composite material. In order to increase tensile strength of a fiber, it is effective to make a microstructure finer. Note, however, that coarsening of a microstructure of a eutectic ceramic fiber which has a fine microstructure is unfortunately easily advanced in a case where the eutectic ceramic fiber is exposed to a high temperature for a long time.

For example, Non-Patent Literature 4 discloses the following. Specifically, an Al₂O₃/Y₃Al₅O₁₂ eutectic composite material produced by a Bridgman method is considered to have a stable microstructure even at 1,973 K (1,700° C.). In contrast, in an Al₂O₃/Y₃Al₅O₁₂ eutectic fiber produced by an edge-defined film-fed growth (EFG) method, crystal grain growth is considered to occur at 1,773 K (1,500° C.), which is lower by 200° C. than 1,973 K (1,700° C.). With attention paid to these points, high temperature stability of a microstructure of an Al₂O₃/Y₃Al₅O₁₂ eutectic composite material produced by an arc melting method has been studied. As a result, it is shown that the microstructure has changed by heat treatment in air at 1,873 K (1,600° C.). Non-Patent Literature 4 indicates that the Al₂O₃/Y₃Al₅O₁₂ eutectic fiber produced by the EFG method and the Al₂O₃/Y₃Al₅O₁₂ eutectic composite material produced by the arc melting method are inferior in high temperature stability of the microstructure to the Al₂O₃/Y₃Al₅O₁₂ eutectic composite material produced by the Bridgman method because the Al₂O₃/Y₃Al₅O₁₂ eutectic fiber produced by the EFG method and the Al₂O₃/Y₃Al₅O₁₂ eutectic composite material produced by the arc melting method have small-sized eutectic microstructures and because the Al₂O₃/Y₃Al₅O₁₂ eutectic composite material produced by the arc melting method also has many defects.

Non-patent Literature 5 illustrates a relationship of a level of a crystal growth rate and a size and a strength (mechanical strength level) of a microstructure of a sapphire/Y₃Al₅O₁₂ eutectic fiber. It is shown that a large microstructure is weak (has a low mechanical strength). Furthermore, Non-patent Literature 5 describes the following: “According to a Petch relationship (Hall-Petch relationship), a finer microstructure is supposed to provide a stronger fiber”. The Hall-Petch relationship is a relationship in which a yield point or tensile strength of a polycrystalline body increases as a crystal grain size decreases. The relationship is represented by a relational expression below. Non-patent Literature 5 suggests that an increase in microstructure results in a decrease in tensile strength also in a eutectic fiber as in the case of a polycrystalline body.

$${σ}_{y} = {σ}_{0} + {k}_{y} {d}^{- 1 / 2}$$

where: d is a crystal grain size;
σ_{y} is a yield point or tensile strength at the crystal grain size d;
σ₀ is a reference yield point or tensile strength; and
k_{y} is a constant of proportionality.

### CITATION LIST

### Patent Literature

### [Patent Literature 1]

Japanese Patent Application Publication Tokukai No. 2015-094055

### [Patent Literature 2]

Japanese Patent Application Publication Tokukaihei No. 11-278994

### Non-Patent Literature

### [Non-Patent Literature 1]

Journal of the Japan Institute of Metals and Materials Vol. 64 No. 2 (2000) 101-107

### [Non-Patent Literature 2]

Japanese Journal of Applied Physics, Vol. 38 (1999) pp. L55-L58

### [Non-Patent Literature 3]

Journal of Crystal Growth, 218 (2000) 67-73

### [Non-Patent Literature 4]

Journal of the Ceramic Society of Japan 109<1>66-70 (2001)

### [Non-Patent Literature 5]

Journal of Korean Association of Crystal Growth Vol. 9, No. 4 (1999) 432-436

### SUMMARY OF INVENTION

### Technical Problem

Thus, an object of the present invention is to provide a eutectic ceramic fiber which has high tensile strength and whose microstructure is not easily coarsened even in a case where the eutectic ceramic fiber is exposed to high temperature air for a long time.

### Solution to Problem

In order to achieve the above object, the inventors of the present invention repeatedly carried out diligent research. The inventors of the present invention accomplished the present invention by finding that a eutectic ceramic fiber having a characteristic structure of a microstructure composed of (i) a matrix of specific compounds, the matrix being a continuous phase, and (ii) specific rod-shaped compounds which are present in such a manner as to be dispersed in the matrix in a specific orientation has high tensile strength and that a microstructure of the eutectic ceramic fiber is less likely to be coarsened even in a case where the eutectic ceramic fiber is exposed to high temperature air for a long time.

That is, an aspect of the present invention is a eutectic ceramic fiber including: a Y₃Al₅O₁₂ matrix; and rod-shaped Y₂O₃-containing cubic crystals of ZrO₂ present in such a manner as to be dispersed in the Y₃Al₅O₁₂ matrix, the Y₃Al₅O₁₂ matrix being a continuous phase, and the rod-shaped Y₂O₃-containing cubic crystals of ZrO₂ being oriented in a longitudinal direction of the eutectic ceramic fiber.

An aspect of the present invention is a eutectic ceramic fiber aggregate including a eutectic ceramic fiber described above.

### Advantageous Effects of Invention

An aspect of the present invention makes it possible to provide a eutectic ceramic fiber which has high tensile strength and whose microstructure is not easily coarsened even in a case where the eutectic ceramic fiber is exposed to high temperature air for a long time.

### BRIEF DESCRIPTION OF DRAWINGS

FIG. 1 is a diagram schematically illustrating an example of a shape of a crucible that can be used to produce a eutectic ceramic fiber in accordance with an embodiment of the present invention.

FIG. 2 is a diagram schematically illustrating an example of a structure of a main part of a micro-pulling-down apparatus that can be used to produce the eutectic ceramic fiber in accordance with an embodiment of the present invention.

FIG. 3 is a diagram of a low magnification scanning electron microscope photograph (backscattered electron image) of a cross section perpendicular to a longitudinal direction of a eutectic ceramic fiber obtained in an embodiment of the present invention.

FIG. 4 is a diagram of a high magnification scanning electron microscope photograph (backscattered electron image) of the cross section perpendicular to the longitudinal direction of the eutectic ceramic fiber obtained in an embodiment of the present invention.

FIG. 5 is a diagram of a scanning electron microscope photograph (backscattered electron image) of a surface of the eutectic ceramic fiber obtained in an embodiment of the present invention.

FIG. 6 is a diagram of a scanning electron microscope photograph (backscattered electron image) of a cross section parallel to the longitudinal direction of the eutectic ceramic fiber obtained in an embodiment of the present invention.

FIG. 7 is a diagram of a low magnification scanning electron microscope photograph (backscattered electron image) of a cross section perpendicular to a longitudinal direction of a eutectic ceramic fiber of Comparative Example 1.

FIG. 8 is a diagram of a high magnification scanning electron microscope photograph (backscattered electron image) of the cross section perpendicular to the longitudinal direction of the eutectic ceramic fiber of Comparative Example 1.

FIG. 9 is a diagram of a high magnification scanning electron microscope photograph (backscattered electron image) of a cross section perpendicular to a longitudinal direction of a eutectic ceramic fiber of a reference example.

### DESCRIPTION OF EMBODIMENTS

The following description will discuss the present invention in detail. Note that the numerical range “A to B” herein means “not less than A and not more than B”.

### [Eutectic Ceramic Fiber]

A eutectic ceramic fiber in accordance with an embodiment of the present invention includes: a Y₃Al₅O₁₂ matrix; and rod-shaped Y₂O₃-containing cubic crystals of ZrO₂ present in such a manner as to be dispersed in the Y₃Al₅O₁₂ matrix.

The Y₃Al₅O₁₂ matrix is a continuous phase. Note here that the “continuous phase” means a phase in which there are no plurality of domains in a macroscopic view. The “continuous phase” is a phase in which no clear interface is observed in the Y₃Al₅O₁₂ matrix by, for example, scanning electron microscopic observation. The “continuous phase” can include a phase in which an interface is observed in some of the Y₃Al₅O₁₂ matrix, provided that the continuous phase does not affect any characteristic.

The Y₃Al₅O₁₂ matrix is preferably a single crystal in order to suppress variation in tensile strength. It can be determined by the following method that the Y₃Al₅O₁₂ matrix is a single crystal. Specifically, an electron backscattered diffraction pattern (hereafter may be abbreviated as “EBSD”) method is used to carry out a crystal orientation analysis of the Y₃Al₅O₁₂ matrix in a cross section perpendicular to a longitudinal direction of the eutectic ceramic fiber and two cross sections parallel to the longitudinal direction and orthogonal to each other. A resulting crystal orientation map makes it possible to determine that the Y₃Al₅O₁₂ matrix is a single crystal. In a case where the Y₃Al₅O₁₂ matrix is monochromatic in the crystal orientation map in all the cross sections, it is possible to determine that the Y₃Al₅O₁₂ matrix is a single crystal.

The Y₂O₃-containing cubic ZrO₂ is a crystalline substance stabilized, by substituting some of Zr atoms with Y atoms by Y₂O₃ contained in ZrO₂ that is originally a monoclinic system, in a cubic system which does not cause phase transition in a high temperature region.

The Y₂O₃-containing cubic ZrO₂ is rod-shaped. A plurality of Y₂O₃-containing cubic crystals of ZrO₂ are present in such a manner as to be dispersed in the Y₃Al₅O₁₂ matrix, which is the continuous phase. Some of surfaces of some of the Y₂O₃-containing cubic crystals of ZrO₂ may be exposed from a surface of the eutectic ceramic fiber.

The rod-shaped Y₂O₃-containing cubic crystals of ZrO₂ are oriented in the longitudinal direction of the eutectic ceramic fiber. Note here that “the rod-shaped Y₂O₃-containing cubic crystals of ZrO₂ are oriented in the longitudinal direction of the eutectic ceramic fiber” means that an average of inclinations of the rod-shaped Y₂O₃-containing cubic crystals of ZrO₂ is not more than 150 with respect to the longitudinal direction of the eutectic ceramic fiber.

A fiber diameter of the eutectic ceramic fiber can be adjusted by a crucible minute hole diameter and a pulling-down speed which are described later. From the viewpoint of tensile strength and flexibility, the fiber diameter is preferably not more than 300 μm, more preferably not more than 160 μm, even more preferably not more than 90 μm, and particularly preferably not less than 20 μm and not more than 70 μm. The eutectic ceramic fiber can be continuously spun and has an aspect ratio of preferably not less than 10, more preferably not less than 100, and particularly preferably not less than 300.

The fiber diameter of the eutectic ceramic fiber is measured with use of an LED projection outer diameter measurement device (LS9006M available from KEYENCE CORPORATION). Outer diameters at a total of five places that are a center of the fiber having a length of 25 mm (a 12.5 mm position from an end of the fiber) and 5 mm and 10 mm positions from the center toward both ends of the fiber are measured, and an average of the outer diameters is regarded as the fiber diameter of the eutectic ceramic fiber.

In order to both suppress microstructure coarsening caused by exposure to a high temperature and achieve tensile strength, the eutectic ceramic fiber is preferably configured such that an average distance between adjacent ones of the rod-shaped Y₂O₃-containing cubic crystals of ZrO₂ is 0.2 μm to 0.7 μm in a plane perpendicular to the longitudinal direction of the eutectic ceramic fiber.

In the present invention, the average distance between the rod-shaped Y₂O₃-containing cubic crystals of ZrO₂ is determined as below with use of image analysis software.

A scanning electron microscope (JSM-IT500 available from JEOL Ltd.) is used to acquire a backscattered electron image of a polished cross section perpendicular to the longitudinal direction of the eutectic ceramic fiber, the backscattered electron image including at least 500 independent Y₂O₃-containing cubic crystals of ZrO₂. Image analysis software (WinROOF2018 available from MITANI CORPORATION) is used to calibrate a scale in the image analysis software by a scale bar inside the backscattered electron image. Subsequently, the image analysis software is used to replace the backscattered electron image with a 256-level gray scale, remove noise with use of a median filter having a kernel size of 5 pixels×5 pixels, and extract a pixel included in 165 to 255 levels of 256 levels [0 (dark) to 255 (bright)]. That is, the extracted pixel corresponds to the Y₂O₃-containing cubic ZrO₂. Then, a Voronoi region in which gravity center coordinates of each extracted region are used as a generating point is calculated, and a line segment connecting generating points of adjacent Voronoi regions is drawn. An arithmetic mean of lengths of the respective line segments is regarded as the average distance between the rod-shaped Y₂O₃-containing cubic crystals of ZrO₂.

The Y₂O₃-containing cubic ZrO₂ can also contain HfO₂. The HfO₂ is an oxide isomorphic to ZrO₂ and has properties similar to those of ZrO₂. Thus, in the eutectic ceramic fiber, an Hf atom can substitute at least some of a Zr site of the Y₂O₃-containing cubic ZrO₂. A rod-shaped Y₂O₃-containing cubic ZrO₂ whose Zr site has been substituted with an Hf atom is also expected to bring about an effect that is at least equivalent to an effect brought about by the Y₂O₃-containing cubic ZrO₂ to which no HfO₂ is added during production.

The eutectic ceramic fiber may further contain an ingredient(s) other than the above-described components provided that an effect of the present invention can be obtained. For example, the eutectic ceramic fiber may further contain a trace amount(s) of other element(s) mixed during production, provided that the effect of the present invention can be obtained.

### [Production of Eutectic Ceramic Fiber]

The following description will discuss, with reference to an example, a method for producing the eutectic ceramic fiber.

The eutectic ceramic fiber can be manufactured by, for example, unidirectionally solidifying a melt of a composition with a molar ratio of Y₂O₃:Al₂O₃:ZrO₂=36.80:51.95:11.25 by a micro-pulling-down method that is a type of unidirectional solidification method. Note here that the micro-pulling-down method is a method in which a raw material is melted in a crucible with a pore at its lower end so that a melt is allowed to flow out through the pore, and a seed crystal provided below the crucible is pulled down while being brought into contact with the melt so as to form a solid-liquid interface below the crucible, so that a crystal is unidirectionally grown from the melt.

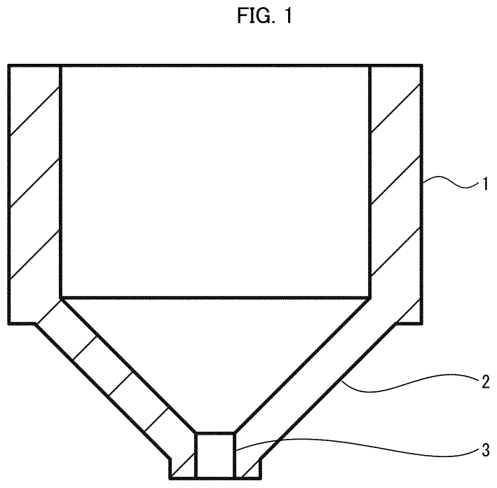

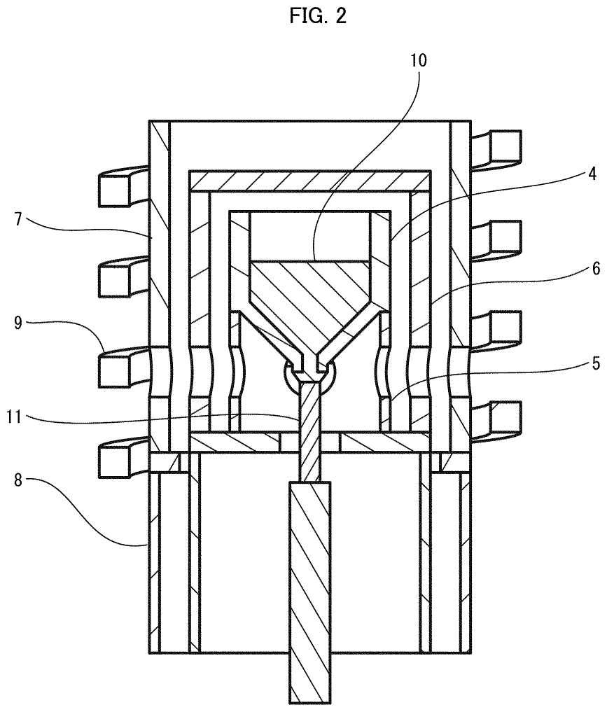

FIG. 1 schematically illustrates an example of a shape of a crucible that can be used to produce a eutectic ceramic fiber in accordance with an embodiment of the present invention. FIG. 2 schematically illustrates an example of a structure of a main part of a micro-pulling-down apparatus that can be used to produce the eutectic ceramic fiber in accordance with an embodiment of the present invention. The following description will discuss a method for producing the eutectic ceramic fiber by the micro-pulling-down method.

The eutectic ceramic fiber can be produced with use of a crucible having a shape as illustrated in FIG. 1. The crucible includes a cylindrical straight trunk part 1, a hollow cone-shaped tapered part 2 directly connected to a lower end of the straight trunk part, and a nozzle hole 3 with a circular through hole at a center of a lower end of the tapered part. Examples of a material of the crucible include high melting point metals such as Mo, W, Ir, and alloys containing these metals as main components. From the viewpoint of preventing or reducing contamination of the eutectic ceramic fiber with a metal and the viewpoint of preventing or reducing creep deformation in the crucible, a Mo crucible in which these viewpoints are relatively well balanced can be particularly suitably used to produce the eutectic ceramic fiber.

As illustrated in FIG. 2, the Mo crucible containing an oxide melting raw material is set in the micro-pulling-down apparatus so as to melt the oxide melting raw material and produce the eutectic ceramic fiber. In the micro-pulling-down apparatus used to produce the eutectic ceramic fiber, a crucible 4 made of Mo is provided, an after-heater 5 made of Mo is provided below the crucible, and a porous ZrO₂ heat insulating material 6 is provided so as to surround the crucible 4 and the after-heater 5. On the outside of a side surface of the porous ZrO₂ heat insulating material 6, an Al₂O₃ tube 7 is provided, and the porous ZrO₂ heat insulating material 6 and the Al₂O₃ tube 7 are placed on a quartz tube 8.

The crucible 4 made of Mo is directly heated by being subjected to induction heating by a high frequency coil 9 provided on the outside of the Al₂O₃ tube 7, and the oxide melting material contained in the crucible 4 is melted into a melt 10. Then, the melt 10 is unidirectionally solidified by bringing a seed crystal 11 provided below the crucible 4 into contact with the melt 10 while lifting the seed crystal 11, and pulling down the seed crystal 11 while forming a solid-liquid interface below the crucible 4, so that the eutectic ceramic fiber can be produced. In this case, a temperature gradient at or near the solid-liquid interface during unidirectional solidification of the melt can be adjusted by changing the height of the after-heater 5 made of Mo and a vertical arrangement of the after-heater 5. The after-heater 5 has a side surface provided with a hole. A high frequency output of the after-heater 5 is adjusted, while the lower end of the crucible 4 and the solid-liquid interface are being observed through the hole with use of a CCD camera, so as to bring the seed crystal 11 into contact with the melt 10 and pull down the seed crystal 11. In this way, the eutectic ceramic fiber can be produced.

By causing atmosphere in this case to be an Ar gas or an Ar+H₂ mixed gas containing Ar and a trace amount of H₂, it is possible to further suppress oxidative degradation of the crucible 4 made of Mo and the after-heater 5 made of Mo.

As described earlier, for example, a composition with a molar ratio of Y₂O₃:Al₂O₃:ZrO₂=36.80:51.95:11.25 can be used as the oxide melting raw material in the present invention. HfO₂ can also be used in place of some of ZrO₂. A form of the oxide melting raw material may be any one of powder, a molded body, a sintered body, and a solidified body. Note, however, that a sintered body or a solidified body is preferable in order to suppress contamination with a metal.

### [Eutectic Ceramic Fiber Aggregate]

A eutectic ceramic fiber aggregate in accordance with an embodiment of the present invention includes a eutectic ceramic fiber described above. The eutectic ceramic fiber aggregate is configured by, for example, processing only a ceramic fiber. Examples of the eutectic ceramic fiber aggregate include eutectic ceramic fiber wool, a plate or sheet material obtained by pressing a eutectic ceramic fiber, a eutectic ceramic fiber strand, and eutectic ceramic fiber nonwoven fabric and woven fabric.

Aspects of the present invention can also be expressed as follows:
A eutectic ceramic fiber in accordance with a first aspect of the present invention includes: a Y₃Al₅O₁₂ matrix; and rod-shaped Y₂O₃-containing cubic crystals of ZrO₂ present in such a manner as to be dispersed in the Y₃Al₅O₁₂ matrix, the Y₃Al₅O₁₂ matrix being a continuous phase, and the rod-shaped Y₂O₃-containing cubic crystals of ZrO₂ being oriented in a longitudinal direction of the eutectic ceramic fiber.

In a second aspect of the present invention, a eutectic ceramic fiber is configured such that, in the first aspect, the Y₃Al₅O₁₂ matrix is a single crystal.

In a third aspect of the present invention, a eutectic ceramic fiber is configured such that, in the first or second aspect, an average distance between adjacent ones of the rod-shaped Y₂O₃-containing cubic crystals of ZrO₂ is 0.2 μm to 0.7 μm in a plane perpendicular to the longitudinal direction of the eutectic ceramic fiber.

In a fourth aspect of the present invention, a eutectic ceramic fiber is configured such that, in any one of the first to third aspects, the rod-shaped Y₂O₃-containing cubic crystals of ZrO₂ contain HfO₂.

In a fifth aspect of the present invention, a eutectic ceramic fiber is configured such that, in any one of the first to fourth aspects, the eutectic ceramic fiber has a fiber diameter of 20 μm to 70 μm.

A eutectic ceramic fiber aggregate in accordance with a sixth aspect of the present invention includes a eutectic ceramic fiber described in any one of the first to fifth aspects.

The present invention makes it possible to provide (i) a eutectic ceramic fiber that has high tensile strength and that is suitable as a reinforcing fiber of a high temperature structure ceramic composite material and (ii) an aggregate of the eutectic ceramic fiber. The present invention is expected to contribute to achievement of, for example, Goal 9 “Build resilient infrastructure, promote inclusive and sustainable industrialization and foster innovation” of Sustainable Development Goals (SDGs) proposed by the United Nations.

The present invention is not limited to the above embodiments, but can be altered in various ways within the scope of the claims. The present invention also encompasses, in its technical scope, any embodiment derived by appropriately combining technical means disclosed in differing embodiments.

### EXAMPLES

The following description will discuss the present invention in more detail with reference to specific examples.

### Example 1

Y₂O₃ powder (having a purity of 99.99%), Al₂O₃ powder (having a purity of 99.99%), and ZrO₂ powder (having a purity of 98%) with a molar ratio of Y₂O₃:Al₂O₃:ZrO₂=36.80:51.95:11.25 was subjected to ball mill mixing in ethanol. Resulting slurry was heated to remove the ethanol therefrom so as to prepare mixed powder. The mixed powder thus obtained was molded under pressure into a cylindrical shape having a diameter of 15 mm and a height of 15 mm, and was sintered at 1550° C. in air so as to be a melting material.

Meanwhile, a Mo crucible having a shape illustrated in FIG. 2 was prepared. In the crucible, a straight trunk part has an outer diameter of 16 mm, an inner diameter of 12 mm, and a height of 33 mm. A tapered part has an angle of 90°, and a lower end of the tapered part has an outer diameter (hereinafter may be referred to as “die diameter”) of p 90 μm (a Mo thickness around a nozzle hole is 20 μm). The nozzle hole has a hole diameter of p 50 μm in the crucible. Note that “angle of the tapered part” is an angle in a vertical cross section of the crucible, the angle being formed by extensions of surfaces of the tapered part in the crucible. A sintered body of the melting material was contained in the Mo crucible. A micro-pulling-down apparatus having a structure illustrated in FIG. 2 was used to heat the Mo crucible until the tapered part of the crucible had an outer surface temperature of 1920° C., so that the sintered body was melted into a melt.

Next, while a melted state of the melt was maintained, a Y₃Al₅O₁₂ single crystal oriented in a <001> direction was brought into contact with the melt so as to form a solid-liquid interface below the Mo crucible. Then, the melt was unidirectionally solidified while the Y₃Al₅O₁₂ single crystal was being pulled down at a speed of 15 mm/min, so that a eutectic ceramic fiber having a length of 250 mm was obtained. A total of three eutectic ceramic fibers were produced under identical conditions.

For each of all the eutectic ceramic fibers thus obtained, fiber diameters thereof were measured at five places with use of the outer diameter measurement device (LS9006M available from KEYENCE CORPORATION), and an average of all values was regarded as a fiber diameter of the eutectic ceramic fiber of Example 1.

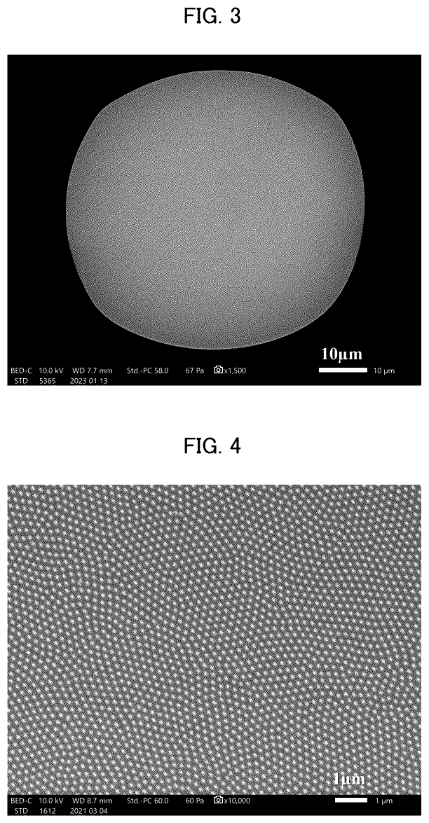

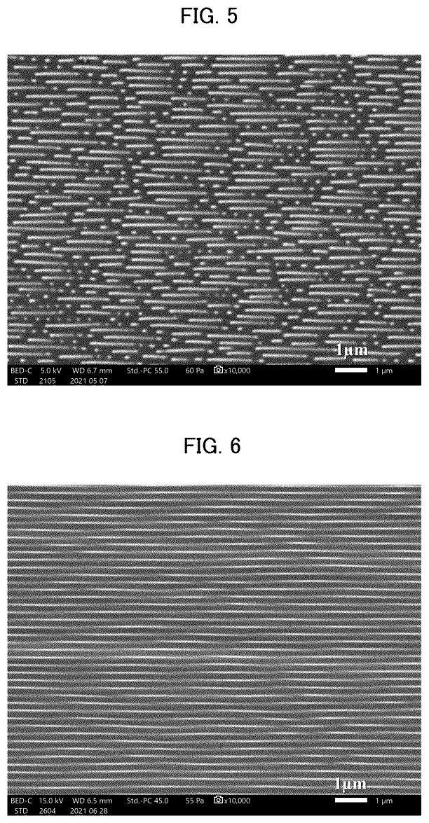

FIG. 3 shows a low magnification scanning electron microscope photograph (backscattered electron image) (with an entire cross section in a field of view) of a cross section perpendicular to a longitudinal direction of an obtained eutectic ceramic fiber. FIG. 4 shows a high magnification scanning electron microscope photograph (backscattered electron image) of the cross section. FIG. 5 shows a scanning electron microscope photograph (backscattered electron image) of a surface of the obtained eutectic ceramic fiber. FIG. 6 shows a scanning electron microscope photograph (backscattered electron image) of a cross section parallel to the longitudinal direction of the eutectic ceramic fiber. In FIGS. 5 and 6, a transverse direction in the shown photographs is the longitudinal direction of the fiber. These images are composed of a relatively dark matrix and relatively bright rod-shaped phases present in such a manner as to be dispersed in a matrix, and no interface between matrices is observed from inside the matrices. These images have confirmed that the matrix is a continuous phase and that some of the rod-shaped phases are exposed on the surface of the eutectic ceramic fiber.

Results of an X-ray diffraction pattern of a ground sample (powder) and an elemental analysis with use of an energy-dispersive X-ray spectroscopy device (EDS) installed in a scanning electron microscope show that the obtained eutectic ceramic fiber has a matrix which is Y₃Al₅O₁₂ and a rod-shaped phase which is a Y₂Zr₂O₇ or Y₂O₃-containing cubic ZrO₂. A rod-shaped phase electron diffraction pattern of a sample produced by cutting the eutectic ceramic fiber perpendicularly to the longitudinal direction of the eutectic ceramic fiber and thinning the eutectic ceramic fiber, the rod-shaped phase electron diffraction pattern having been obtained by scanning transmission electron microscopic observation of a plane perpendicular to the longitudinal direction of the eutectic ceramic fiber, has determined that the rod-shaped phase is a Y₂O₃-containing cubic ZrO₂.

A crystal orientation analysis of the obtained eutectic ceramic fiber was carried out by the EBSD method assuming that a cross section perpendicular to the longitudinal direction of the eutectic ceramic fiber is a measuring plane. The crystal orientation analysis was carried out assuming that a direction parallel to the longitudinal direction of the eutectic ceramic fiber is a normal direction (ND) and that two directions perpendicular to the longitudinal direction and orthogonal to each other are a reference direction (RD) and a transverse direction (TD). Y₃Al₅O₁₂ matrices in an obtained crystal orientation map in three planes perpendicular to the ND, RD, and TD directions were all monochromatic. This has confirmed that the Y₃Al₅O₁₂ matrix of the obtained eutectic ceramic fiber is a single crystal.

A matrix electron diffraction pattern of a sample produced by cutting the eutectic ceramic fiber perpendicularly to the longitudinal direction of the eutectic ceramic fiber and thinning the eutectic ceramic fiber, the matrix electron diffraction pattern having been obtained by scanning transmission electron microscopic observation of a plane perpendicular to the longitudinal direction of the eutectic ceramic fiber, coincided with a diffraction pattern in the <001> direction of Y₃Al₅O₁₂. This has shown that the matrix of the obtained eutectic ceramic fiber is a single crystal and that a (001) plane of Y₃Al₅O₁₂ coincides with a plane perpendicular to the longitudinal direction of the eutectic ceramic fiber, i.e., that the matrix is oriented in the <001> direction of Y₃Al₅O₁₂.

A tensile test at room temperature (25° C.) was carried out with respect to the obtained eutectic ceramic fiber at a test length of 25 mm and a crosshead speed of 2 mm/min. A cross-sectional area of the eutectic ceramic fiber was determined from the fiber diameter (diameter) of the eutectic ceramic fiber, the fiber diameter having been calculated as described earlier, and tensile strength of the eutectic ceramic fiber of Example 1 was calculated.

The obtained eutectic ceramic fiber was exposed to air at 1,500° C. for 50 hours so as to measure a rod-to-rod distance in a rod-shaped Y₂O₃-containing cubic ZrO₂ before and after exposure. Then, a ratio of the rod-to-rod distance after exposure to the rod-to-rod distance before exposure was calculated, and the ratio was regarded as a change in rod-to-rod distance.

Table 1 shows room temperature tensile strength of the eutectic ceramic fiber together with a production condition for the eutectic ceramic fiber (a nozzle hole diameter of the crucible, a die diameter of the crucible, a seed crystal, and a pulling-down speed), a constituent phase and a fiber diameter of the obtained eutectic ceramic fiber, a rod-to-rod distance in the rod-shaped Y₂O₃-containing cubic ZrO₂ (denoted as c-ZrO₂ in Table 1) before and after exposure to air at 1,500° C. for 50 hours and a change in rod-to-rod distance, and an aspect of a matrix. Note that a median of tensile strength of nine test pieces was set as the tensile strength of the eutectic ceramic fiber in Table 1. The rod-to-rod distance in the rod-shaped Y₂O₃-containing cubic ZrO₂ (denoted as “c-ZrO₂ rod-to-rod distance” in Table 1) was determined by the above-described method in which image analysis software is used.

Room temperature tensile strength can be set as appropriate in accordance with a purpose for which the eutectic ceramic fiber is used. It is herein determined that a room temperature tensile strength of not less than 1.8 causes no practical problem. The change in rod-to-rod distance after exposure to air at 1,500° C. for 50 hours can also be set as appropriate in accordance with a purpose for which the eutectic ceramic fiber is used or a condition under which the eutectic ceramic fiber is used. It is herein determined that a rate of change of not more than 110% causes no practical problem.

TABLE 1

| | Production condition | | | | | |
|---|---|---|---|---|---|---|
| | | Crucible | | Pulling- | Eutecic ceramic fiber after exposure to 1,500° C. for 50 h | |
| | Crucible die | nozzle hole | | down | | Fiber |
| | diameter | diameter | | speed | Constituent | diameter |
| Example | (μm) | (μm) | Seed crystal | (mm/min) | phase | (μm) |
| Example 1 | 90 | 50 | Y [symbol] Al [symbol] O [symbol] | 15 | Y [symbol] Al [symbol] O [symbol] ZrO [symbol] | 63.7 |
| Example 2 | | | single | 10 | | 72.1 |
| Example 3 | | | crystal | 5 | | 79.8 |
| Example 4 | | | [001] | 2 | | 85.2 |
| Example 5 | | | | 20 | | 50.9 |
| Example 6 | 140 | 100 | | 15 | | 145.1 |
| Example 7 | | | | 10 | | 150.0 |
| Example 8 | 240 | 200 | | 15 | | 259.6 |
| Example 9 | | | | 10 | | 260.3 |

| | Eutecic ceramic fiber after exposure to 1,500° C. for 50 h | | | Eutecic ceramic fiber | |
|---|---|---|---|---|---|
| | | | Room | | Change |
| | | o-ZrO [symbol] | temperature | o-ZrO [symbol] | in o-ZrO [symbol] |
| | | rod-to-rod | tensile | rod-to-rod | rod-to-rod |
| | | distance | strength | distance | distance |
| Example | Matrix | (μm) | (GPa) | (μm) | (%) |
| Example 1 | Y [symbol] Al [symbol] O [symbol] | 0.25 | 2.98 | 0.2 [symbol] | 108 |
| Example 2 | single | 0.31 | 2.72 | 0.32 | 103 |
| Example 3 | crystal | 0.42 | 2.29 | 0.44 | 105 |
| Example 4 | [001] | 0.65 | 1.83 | 0.65 | 100 |
| Example 5 | | 0.23 | 3.11 | 0.24 | 104 |
| Example 6 | | 0.2 [symbol] | 2.42 | 0.27 | 104 |
| Example 7 | | 0.31 | 2.17 | 0.32 | 103 |
| Example 8 | | 0.2 [symbol] | 2.30 | 0.2 [symbol] | 100 |
| Example 9 | | 0.31 | 2.10 | 0.32 | 103 |

[symbol]

indicates data missing or illegible when filed

### Examples 2 to 5

Eutectic ceramic fibers of Examples 2 to 5 were produced as in the case of Example 1 except that the pulling-down speed was changed as shown in Table 1. For each of the eutectic ceramic fibers thus obtained, a fiber diameter and room temperature tensile strength were measured as in the case of Example 1, a constituent phase of a fiber and an aspect of a matrix were determined, a rod-to-rod distance in a Y₂O₃-containing cubic ZrO₂ before and after exposure to air at 1,500° C. for 50 hours was measured, and a change in rod-to-rod distance after exposure was calculated. Results are shown in Table 1 as in the case of Example 1.

### Examples 6 to 9

Eutectic ceramic fibers of Examples 6 to 9 were produced as in the case of Example 1 except that the die diameter and the nozzle diameter of the crucible and the pulling-down speed were changed as shown in Table 1. For each of the eutectic ceramic fibers thus obtained, a fiber diameter and room temperature tensile strength were measured as in the case of Example 1, a constituent phase of a fiber and an aspect of a matrix were determined, a rod-to-rod distance in a Y₂O₃-containing cubic ZrO₂ before and after exposure to air at 1,500° C. for 50 hours was measured, and a change in rod-to-rod distance after exposure was calculated. Results are shown in Table 1 as in the case of Example 1.

### Comparative Example 1

A eutectic ceramic fiber of Comparative Example 1 was produced as in the case of Example 1 except that Y₂O₃ powder (having a purity of 99.99%) and Al₂O₃ powder (having a purity of 99.99%) with a molar ratio of Al₂O₃:Y₂O₃=82:18 were used as raw materials of mixed powder, a melting temperature of a sintered body was set to 1,870° C. which was an outer surface temperature of a crucible tapered part of a Mo crucible, and an Al₂O₃ single crystal oriented in a [11-20] direction was used for a seed crystal. A fiber diameter and room temperature tensile strength of the eutectic ceramic fiber thus produced were measured as in the case of Example 1. The obtained eutectic ceramic fiber was exposed to air at 1,500° C. for 50 hours as in the case of Example 1. A microstructure size of the eutectic ceramic fiber before and after exposure was converted into numerical form by a method described later, and a change in microstructure size was calculated.

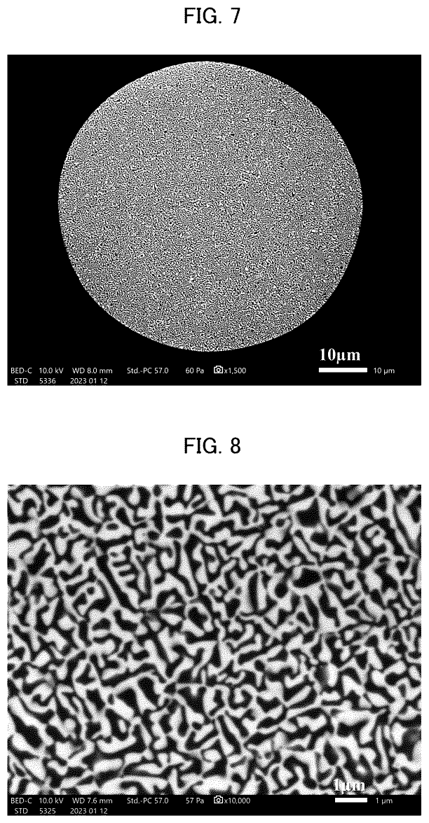

FIG. 7 shows a low magnification scanning electron microscope photograph (backscattered electron image) (with an entire cross section in a field of view) of a cross section perpendicular to a longitudinal direction of the obtained eutectic ceramic fiber. FIG. 8 shows a high magnification scanning electron microscope photograph (backscattered electron image) of the cross section. These images show a lamellar eutectic microstructure. It has been observed that the lamellar eutectic microstructure is composed of two phases which are a relatively dark phase and a relatively bright phase. Results of an X-ray diffraction pattern of a ground sample (powder) and an elemental analysis with use of an energy-dispersive X-ray spectroscopy device (EDS) installed in a scanning electron microscope show that the obtained eutectic ceramic fiber has a dark phase which is Al₂O₃ and a bright phase which is Y₃Al₅O₁₂.

A microstructure size of the eutectic ceramic fiber of Comparative Example 1 was converted into numerical form by the following method.

A scanning electron microscope (JSM-IT500 available from JEOL Ltd.) was used to acquire a backscattered electron image (size of field of view: 19.2 μm×25.6 μm) of a polished cross section perpendicular to the longitudinal direction of the eutectic ceramic fiber. Image analysis software (WinROOF2018 available from MITANI CORPORATION) was used to calibrate a scale in the image analysis software by a scale bar inside the backscattered electron image. Subsequently, the image analysis software was used to replace the backscattered electron image with a 256-level gray scale image, remove noise with use of a median filter having a kernel size of 5 pixels×5 pixels, and carry out binarization in which a pixel included in 0 to 128 levels of 256 levels [0 (dark) to 255 (bright)] is classified as class 1, and a pixel included in 129 to 255 levels of the 256 levels is classified as class 2. That is, in a binarized image, a class 1 region was caused to correspond to Al₂O₃, and a class 2 region was caused to correspond to Y₃Al₅O₁₂. Then, the image analysis software was used to draw five linear analysis regions at random on the binarized image, extract all boundary points between the class 1 region and the class 2 region in the analysis regions, and then draw, in each of the analysis regions, line segments connecting adjacent boundary points. Note, however, that in a case where a total number of drawn line segments was less than 50, analysis regions were added until the total number reached not less than 50. An arithmetic mean of lengths of all line segments drawn in the obtained image was regarded as an Al₂O₃—Y₃Al₅O₁₂ interlayer distance.

Table 2 shows room temperature tensile strength of the obtained eutectic ceramic fiber, the above interlayer distance before and after exposure to air at 1,500° C. for 50 hours, and a change in interlayer distance after exposure together with a production condition for the eutectic ceramic fiber (a nozzle hole diameter of the crucible, a die diameter of the crucible, a seed crystal, and a pulling-down speed), and a constituent phase and a fiber diameter of the obtained eutectic ceramic fiber.

TABLE 2

| | Production condition | | | | |
|---|---|---|---|---|---|
| | Crucible | Crucible | | Pulling- | |
| | die | nozzle hole | | down | E [symbol] ceramic fiber after exposure to 1,500° C. for 50 h |
| Comparative | diameter | diameter | Seed | speed | Constituent |
| Example | (μm) | (μm) | crystal | (mm/min) | phase |
| Comparative | 90 | 50 | Al [symbol] O [symbol] | 15 | Al [symbol] O [symbol] Y [symbol] Al [symbol] O [symbol] |
| Example 1 | | | single | | |
| | | | crystal | | |
| | | | [11-20] | | |
| Comparative | | | | 10 | |
| Example 2 | | | | | |
| Comparative | | | | 5 | |
| Example 3 | | | | | |
| Comparative | | | | 2 | |
| Example 4 | | | | | |
| Comparative | | | | 20 | |
| Example 5 | | | | | |
| Comparative | 140 | 100 | | 15 | |
| Example 6 | | | | | |
| Comparative | | | | 10 | |
| Example 7 | | | | | |
| Comparative | 240 | 200 | | 15 | |
| Example 8 | | | | | |
| Comparative | | | | 10 | |
| Example 9 | | | | | |

| | | | | E [symbol] ceramic fiber | |
|---|---|---|---|---|---|
| | E [symbol] ceramic fiber after exposure to 1,500° C. for 50 h | | | | Change in |
| | | Room | Al [symbol] O [symbol] | Al [symbol] O [symbol] | Al [symbol] O [symbol] |
| | | temperature | Y [symbol] A [symbol] O [symbol] 12 | Y [symbol] Al [symbol] O [symbol] 12 | Y [symbol] Al [symbol] O1 [symbol] 12 |
| | Fiber | tensile | interlayer | interlayer | interlayer |
| Comparative | diameter | strength | distance | distance | distance |
| Example | (μm) | (GPa) | (μm) | (μm) | (%) |
| Comparative | [symbol] | 2.19 | [symbol] | 1.08 | 177 |
| Example 1 | | | | | |
| Comparative | 77.0 | [symbol] | [symbol] | 1.30 | [symbol] |
| Example 2 | | | | | |
| Comparative | [symbol] | 1.48 | 1.34 | 1.52 | 113 |
| Example 3 | | | | | |
| Comparative | [symbol] | 1.21 | 2.34 | [symbol] | 111 |
| Example 4 | | | | | |
| Comparative | [symbol] | 2.37 | [symbol] | 1.13 | 179 |
| Example 5 | | | | | |
| Comparative | [symbol] | [symbol] | [symbol] | 1.05 | 175 |
| Example 6 | | | | | |
| Comparative | [symbol] | 1.71 | [symbol] | 1.28 | 144 |
| Example 7 | | | | | |
| Comparative | [symbol] | 1.70 | 0.58 | 1.03 | 178 |
| Example 8 | | | | | |
| Comparative | [symbol] | 1.49 | 0.87 | 1.23 | 141 |
| Example 9 | | | | | |

[symbol]

indicates data missing or illegible when filed

### Comparative Examples 2 to 9

Eutectic ceramic fibers of Comparative Examples 2 to 9 were produced as in the case of Comparative Example 1 except that the die diameter and the nozzle diameter of the crucible and the pulling-down speed were changed as shown in Table 2. For each of the eutectic ceramic fibers thus obtained, a fiber diameter, room temperature tensile strength, and the interlayer distance before and after exposure to air at 1,500° C. for 50 hours were measured as in the case of Comparative Example 1, a constituent phase of a fiber was determined, and a change in interlayer distance after the exposure was determined. Results are shown in Table 2 as in the case of Comparative Example 1.

### Reference Example

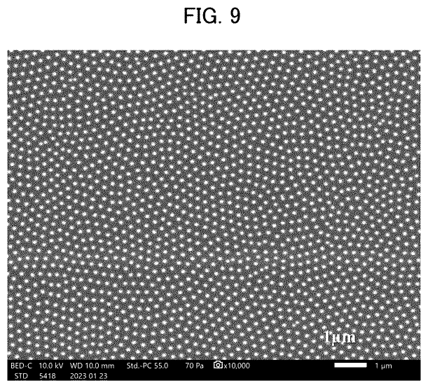

A eutectic ceramic fiber of the present example was produced as in the case of Example 7 except that ZrO₂ serving as the raw material was replaced with HfO₂, mixed powder was prepared by using HfO₂ powder (having a purity of 98%) instead of ZrO₂ powder (having a purity of 98%), and the melting temperature of the sintered body was set to 1,930° C. which was the outer surface temperature of the crucible tapered part of the Mo crucible. FIG. 9 shows a high magnification scanning electron microscope photograph (backscattered electron image) of a cross section perpendicular to a longitudinal direction of the eutectic ceramic fiber thus obtained. The obtained eutectic ceramic fiber had a constituent phase represented by “Y₃Al₅O₁₂/c-HfO₂”, and had a microstructure in which a plurality of rod-shaped Y₂O₃-containing cubic HfO₂s are present in such a manner as to be dispersed in the Y₃Al₅O₁₂ matrix, which is a continuous phase.

As is clear from the above result, the microstructure of the eutectic ceramic fiber of the present example is similar in form to microstructures of the eutectic ceramic fibers of Examples 1 to 9, though rod-shaped crystal phases present in such a manner as to be dispersed in the Y₃Al₅O₁₂ matrix have been changed from the Y₂O₃-containing cubic crystals of ZrO₂ to the Y₂O₃-containing cubic HfO₂s. Zr and Hf have substantially equal atomic radii and substantially equal ionic radii, have very similar electron configurations, and also have similar physicochemical properties. Zr and Hf are also known to be produced together in nature and to be very difficult to be separated. Thus, Zr and Hf form similar compounds, and those compounds also have similar physicochemical properties.

Thus, it can be inferred that the eutectic ceramic fiber of the present example has a microstructure morphology similar to those of the eutectic ceramic fibers of Examples 1 to 9. It is considered that even after exposure to air at 1,500° C. for 50 hours, a rod-to-rod distance of the eutectic ceramic fiber of the present example is less prone to change as in the case of the eutectic ceramic fibers of Examples 1 to 9. According to a comparison between the present example and Example 7, it is considered that in the present invention, all or some of Zr atoms can be replaced with Hf atoms and that a configuration in which some or all of Zr atoms are replaced with Hf atoms also brings about an effect equivalent to at least an effect brought about by a configuration in which no Zr atom is replaced with an Hf atom.

As described above, it is clear that as compared with a eutectic ceramic fiber composed of a conventional constituent phase and a conventional structure of a microstructure, the eutectic ceramic fiber of the present invention has higher tensile strength and is less likely to have a coarsened microstructure even when exposed to high temperature air for a long time.

### INDUSTRIAL APPLICABILITY

A eutectic ceramic fiber of the present invention is used not only as a reinforcing fiber of a high temperature structure ceramic composite material applied to, for example, a gas turbine member, but also as a reinforcing fiber of various composite materials such as a metal composite material. Furthermore, by processing only the eutectic ceramic fiber of the present invention, the eutectic ceramic fiber of the present invention is used in diverse applications as diverse heat-resistant materials such as a heat-resistant mat and a heat-resistant rope.

### REFERENCE SIGNS LIST

1 Straight trunk part
2 Tapered part
3 Nozzle hole
4 Crucible
5 After-heater
6 Porous ZrO₂ heat insulating material
7 Al₂O₃ tube
8 Quartz tube
9 High frequency coil
10 Melt
11 Seed crystal

1. A eutectic ceramic fiber comprising:
a Y₃Al₅O₁₂ matrix; and
rod-shaped Y₂O₃-containing cubic crystals of ZrO₂ present in such a manner as to be dispersed in the Y₃Al₅O₁₂ matrix,
the Y₃Al₅O₁₂ matrix being a continuous phase, and
the rod-shaped Y₂O₃-containing cubic crystals of ZrO₂ being oriented in a longitudinal direction of the eutectic ceramic fiber.

2. The eutectic ceramic fiber as set forth in claim 1, wherein the Y₃Al₅O₁₂ matrix is a single crystal.

3. The eutectic ceramic fiber as set forth in claim 1, wherein an average distance between adjacent ones of the rod-shaped Y₂O₃-containing cubic crystals of ZrO₂ is 0.2 μm to 0.7 μm in a plane perpendicular to the longitudinal direction of the eutectic ceramic fiber.

4. The eutectic ceramic fiber as set forth in claim 1, wherein the rod-shaped Y₂O₃-containing cubic crystals of ZrO₂ contain HfO₂.

5. The eutectic ceramic fiber as set forth in claim 1, wherein the eutectic ceramic fiber has a fiber diameter of 20 μm to 70 μm.

6. A eutectic ceramic fiber aggregate comprising a eutectic ceramic fiber recited in claim 1.
